(19) United States
(12) Patent Application Publication
(10) Pub. No.: US 2004/0139014 A1
(43) Pub. Date: Jul. 15, 2004

(54) Anti-fraud remote cash transaction system

(76) Inventors: Yuh-Shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/646,536

(22) Filed: Aug. 21, 2003

Related U.S. Application Data
(60) Provisional application No. 60/438,574, filed on Jan. 9, 2003.
(60) Provisional application No. 60/463,535, filed on Apr. 18, 2003.
(60) Provisional application No. 60/488,985, filed on Jul. 22, 2003.
(60) Provisional application No. 60/488,987, filed on Jul. 22, 2003.
(60) Provisional application No. 60/488,988, filed on Jul. 22, 2003.

(51) Int. Cl. G06F 17/60

(52) U.S. Cl. 705/40; 705/39

(57) ABSTRACT

An effective and efficient solution with anti-fraud protection to conducting remote transactions using cash as the payment instrument at any time, anywhere over the world is implemented through networks from general-purpose financial accounts such as checking, savings, credit card, or debit card accounts. The prayer is authenticated and the availability of funds is verified by the payer's financial institution before the transaction is completed. The payee is authenticated with a machine-readable identification document before the cash payment is issued. The entire transaction is secured in such a way that no party has a chance to alter or dispute any part of the transaction.

### CLAIM FOR PRIORITY

This application claims priority of U.S. provisional patent applications No. 60/438,574 filed on Jan. 9, 2003, No. 60/463,535 filed on Apr. 18, 2003, and Nos. 60/488,985, 60/488,987 and 60/488,988 filed on Jul. 22, 2003, which are hereby incorporated in this application.

### CROSS REFERENCE TO RELATED APPLICATIONS

Certain embodiments of the present invention may find utility in combination with the teachings of our copending applications filed concurrently herewith and hereby incorporated by reference in their entirety:

Anti-Fraud POS Transaction System Ser. No. ______ (attorney docket 7443-101)

Anti-Fraud Document Transaction System Ser. No. ______ (attorney docket 7443-103)

### BACKGROUND OF THE INVENTION

Because of the potential for fraud associated with checks, debit cards, and credit cards, cash is often preferred as the payment instrument for many transactions. For people under legal age and/or with insufficient credit history, cash may be the only available payment instrument for purchasing goods and services.

Although it is convenient to use cash for point-of-sale transactions in which both the payer and the payee are actually present, it is less suitable for remote transactions because cash can be stolen easily during transportation from the payer to the payee, and conducting a remote transaction through cash payment can be complicated and expensive. As a result, some financial institutions provide special services for cash-based remote transactions, wherein the payer transfers cash or cash equivalents to the financial institution, and the payee receives the cash payment at a remote branch of the same financial institution or its affiliate organization.

Since a financial institution only has a limited number of branches, the payer and payee may need to travel a long distance to the branches of the financial institution in order to conduct a cash transaction. It is very inconvenient and expensive to do so. In addition, branches of financial institutions seldom open 24 hours a day, 7 days a week. In the event of an emergency occurring at night or during the weekend and the payee needs cash payment urgently, there may be no solution at all. For example, a traveler, who cannot use checks, credit cards or debit cards, may encounter a major problem when he loses his wallet in the middle of night in a city 3,000 miles away from any relatives or friends.

The USA PATRIOT Act and the Bank Secrecy Act further complicate the situation by requiring financial institutions to conduct customer identification checks and to monitor and report suspicious cash transactions. Financial institutions have to go through a complicated procedure in order to comply with laws. Consequently, financial institutions have to charge high fees in order to cover their cost associated with remote cash transactions. The high cost and overhead to the payer and payee often makes it impractical for them to conduct a remote cash transaction.

With advanced technology, people often conduct transactions remotely through the Internet, telephone, etc. Since there is no easy and accurate way for the merchant to verify the identity of a remote payer, a con artist with a stolen credit card or debit card number or a bank account number can easily commit fraud through remote transactions. Merchants are suffering a huge amount of losses as a result of this kind of fraud. Victims, i.e., the real account holders, have to go through a frustrating process to prove their innocence even if they are not liable for the losses. Therefore, it is important to protect the account information of a credit card, debit card or a bank account during a transaction.

### SUMMARY OF THE INVENTION

The present invention relates generally to financial transactions. More specifically, the present invention provides anti-fraud measures implemented through networks for remote transactions using cash as the payment instrument from general-purpose financial accounts such as checking, savings, credit card, or debit card accounts.

In this document, the terminology “network” or “networks” generally refers to a communication network or networks, which can be wireless or wired, private or public, or a combination of them, and includes the well-known Internet. Similarly, “bank” or “financial institution” generally refers to a financial service provider, either a bank or a non-bank, where financial services are provided; and “bank account” or “financial account” generally refers to an account in a financial institution, either a bank or a non-bank, where financial transactions are conducted through payment instruments such as checks, credit cards, debit cards, electronic fund transfers, etc.

One objective of the present invention is to provide an effective and efficient solution to conduct remote transactions using cash as the payment instrument at any time, anywhere over the world. Another objective is to prevent fraud committed by payees (e.g., cash recipients), payers (i.e., account holders) and/or third parties (i.e., con artists), associated with such transactions.

According to one aspect of the present invention, the payer is authenticated and the availability of funds is verified by the payer's financial institution before the transaction is completed, the funds are immediately secured during the transaction so that the payer cannot deny the transaction later or otherwise commit payer fraud on the payee.

In accordance with another aspect of the present invention, a payee is prevented from entering into an unauthorized transaction or modifying any transaction since only the payer can initiate a transaction for a specific payee with a specific transaction amount so that the payee cannot commit payee fraud.

In accordance with yet another aspect of the present invention, both the payee and the payer are authenticated and the details of the entire transaction are securely verified and maintained in such a way that no third party has a chance to alter any part of the transaction, thereby preventing third party fraud.

### BRIEF DESCRIPTION OF THE FIGURES

FIG. 1 represents certain exemplary embodiments for anti-fraud systems for cash payments to remote payees from a payer's bank account, a credit card account or a debit card account.

FIG. 2 (comprising FIG. 2A and FIG. 2B) is a flow chart for an exemplary process that may be used in the systems of FIG. 1.

### DETAILED DESCRIPTION OF CERTAIN PREFERRED EMBODIMENTS AND COMBINATIONS OF EMBODIMENTS

The present invention is part of a comprehensive suite of anti-fraud payment systems, which are applicable not only to such traditional payment instruments such as checks, credit cards and debit cards, but also to other transaction methodologies that have been or will be developed to support electronic commerce between parties that do not have established credit with one another, and potentially includes a number of embodiments to provide maximum flexibility so that these payment systems can satisfy many different needs, of both sophisticated and unsophisticated users. Accordingly, we will describe in detail only a few examples of certain preferred embodiments and combinations of the embodiments of the present invention; other inventive anti-fraud payment systems are disclosed in or will otherwise be apparent from the above-referenced copending applications.

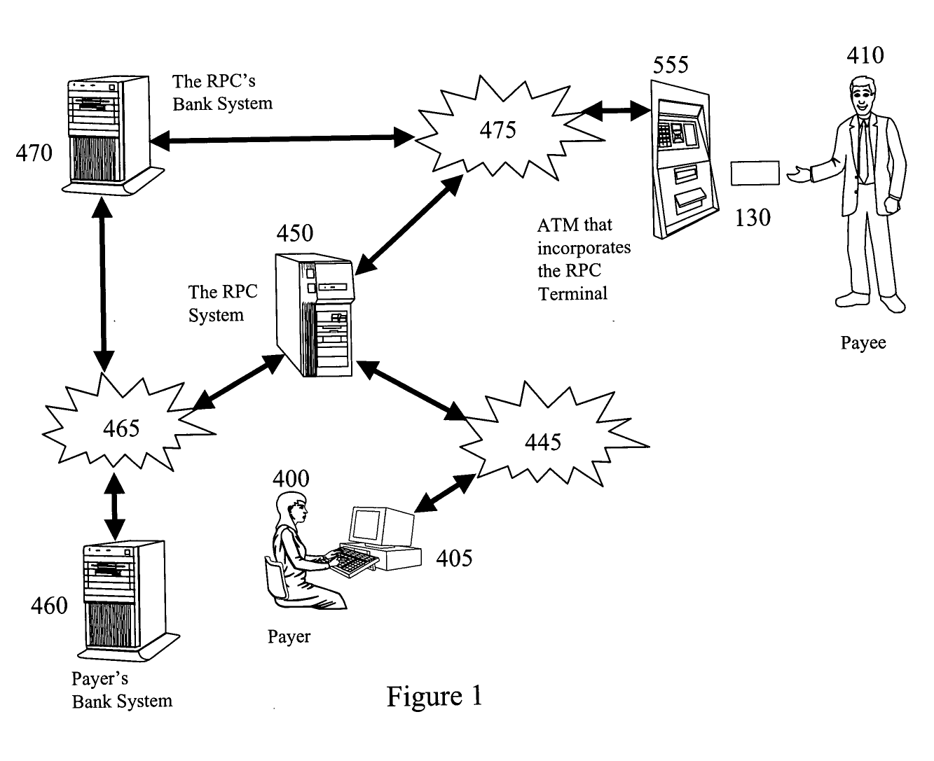

FIG. 1 illustrates certain preferred embodiments of system for conducting remote cash transactions through a bank account, a credit card account or a debit card account, using a Remote Payment Center (“RPC”) 450

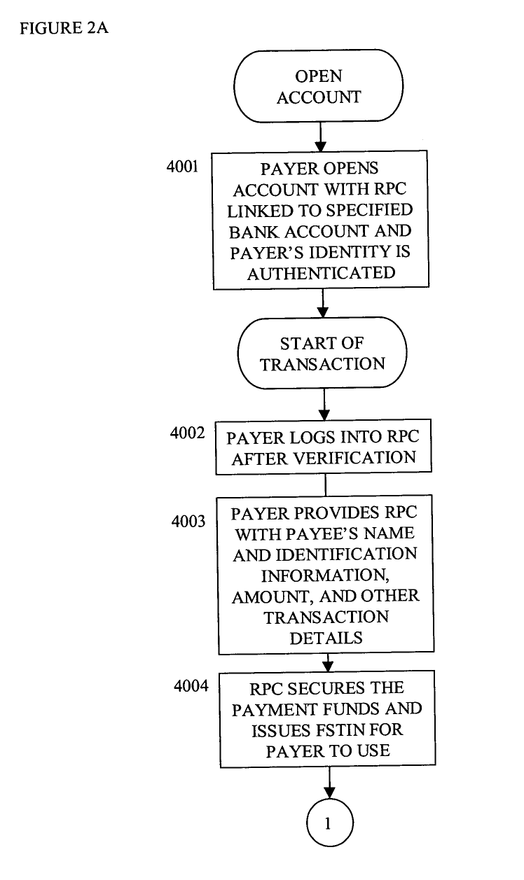

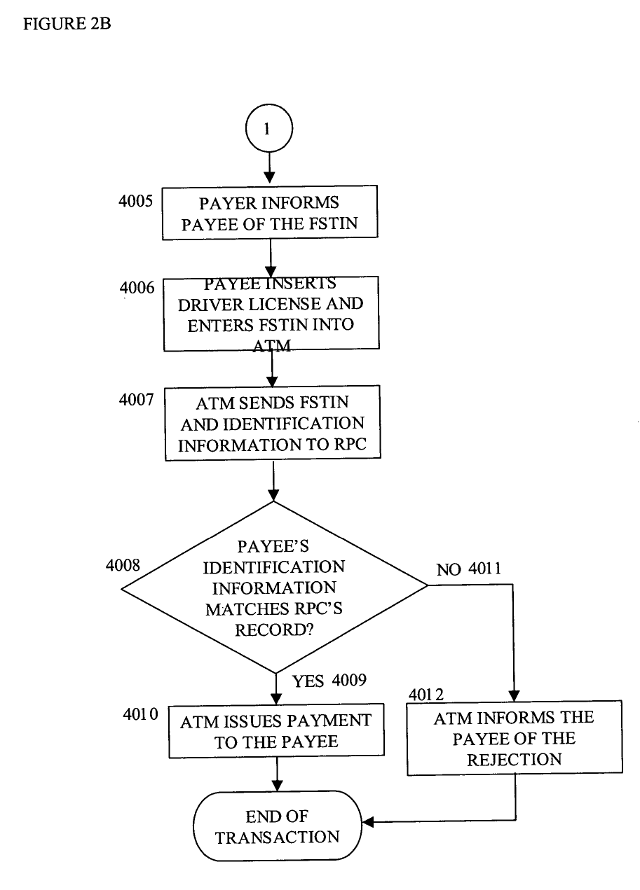

Reference should now be made to the flowchart of FIG. 2 in combination with the system diagram of FIG. 1, which together illustrate the operation of various embodiments of the system aspects of the present invention.

As indicated in block 4001, payer 400 must first open an account with the Remote Payment Center (“RPC”) 450 before being able to enter into any anti-fraud remote cash payment transactions. A comprehensive verification process is required to authenticate the payer's identity. In one embodiment of the present invention, the payer opens the RPC account through his/her existing financial institution 460. Some identification information such as user ID, password, driver's license number, social security number, name, address, data of birth, phone number, etc., must be verified by the payer's financial institution and stored into the customer database of the RPC system. In addition, bank account numbers and credit card or debit card account numbers of the account holder must be authenticated and stored in the customer database of the RPC system. Although as currently contemplated the RPC 450 is independent of the other financial institutions, it could be established exclusively by or for one specific financial institution to provide services to the customers of that financial institution.

In another embodiment of the present invention, the payer 400 opens the RPC account directly through the RPC system 450, for example using a personal computer 405 connected to the RPC system 450 via a secure network 445. The payer has to enter into the RPC system payer's identification information such as user ID, password, driver's license number, social security number, name, address, date of birth, phone number, etc. In addition, bank account numbers and credit card or debit card account numbers of the account holder are preferably entered and stored in the customer database of the RPC system. Then, the RPC system can verify the accuracy of the information provided by the payer through appropriate verification processes before opening an account for the payer.

In yet another alternative embodiment of the present invention, the RPC system operator provides the payer with a small identification verification device (not shown), which can read the machine-readable, embedded coded data of an official identification card (not shown) such as a driver's license or a military ID card. The payer 400 connects the identification device to his/her computer 405 and logs into the RPC system 450 to open an account. This identification device reads the embedded coded identification information from payer's official identification card and sends the information to the RPC system 450, which then verifies payer's identification information with the account holder information of the credit card, debit card, or bank accounts identified by the payer. If the verification is successful, the payer's RPC account is opened and the payer is ready to conduct remote transactions through cash. In other embodiments, a radio frequency identification (“RFID”) device or other wireless data transmission device may be incorporated into the identification card; and the identification information is read from the identification card through an RFID reader or other wireless data receiver.

In still other embodiments, the payer 400 may open the RPC account by means of a public RPC terminal 555, which has incorporated the identification device as described above, and which is connected to the RPC system 450 by means of a secure network 475.

As indicated in block 4002, when the payer 400 intends to issue an anti-fraud remote cash payment, he or she logs into the RPC system 450 through the network 445, In one embodiment of the present invention, the payer logs into the RPC system by entering an assigned User ID and Password. In another embodiment of the present invention, the payer has to use the previously mentioned identification device to log into the RPC system. The identification device reads the embedded coded identification information from payer's official identification card and sends the information to the RPC system for verification. The login will not be approved without an official identification card containing payer's information that matches the account holder information of the RPC account as specified by the payer. If a business account is involved, the official identification card of the signer can be used.

After logging in, the payer 400 enters (block 4003) the payee's name and identification information, dollar amount, and other related information.

As indicated in block 4004, in one preferred embodiment of the present invention, once all the required transaction details have been confirmed, the RPC system 450 immediately transfers funds from the payer's selected account 460 to the RPC's bank account 470 through ATM network (or other competing real-time network) 465. This provision to immediately transfer funds out from the payer's account makes sure that the payer cannot commit any fraud. After the funds are secured, the RPC system 450 issues a Funds Secured Transaction Identification Number (“FSTIN”) for the payer 400 to use.

As indicated in block 4005, the payer then gives this FSTIN to the payee 410. The process of entering information and receiving a “FSTIN” can be completed either manually, or through a computer that runs a secure software package, or an equivalent apparatus such as an advanced phone to do it automatically. In other embodiments, the funds are not so secured in advance, and only a Transaction Identification Number (“TIN”) is issued.

Once the payer has authorized the payment, the payee can request the payment at any RPC service depot. For example, the payee 410 may use an ATM 555 that is connected to the RPC 450 by means of an ATM network 475. In other embodiments, the RPC service depot may be based on a check-cashing terminal or other similar terminals where cash is available for withdrawal, or a stand-alone kiosk. As indicated in block 4006, the payee inserts his driver's license or other identification card 130, and enters the FSTIN or TIN to identify the transaction. The ATM terminal reads the embedded coded identification information of the payee from the identification card and sends it with the FSTIN to the RPC system (block 4007). Registration of the payee with the RPC system and/or verifiable biometric information from the payee may be required to verify the payee's identity for higher security protection.

In other embodiments, the payee may be permitted to log into the RPC system based on the FSTIN or TIN, without any machine readable identification card, particularly if only small dollar amounts are involved. For privacy and security protection, the payee may be prompted to enter some unique personal information about the payee (such as a social security number or a previously registered fingerprint) and/or information about the transaction such as the dollar amount and the payer's name or a password given by the payer.

In embodiments involving larger dollar amounts, the payee may be required to go to a cashier at a full service bank to request a cash payment from the RPC's bank. This action may be indicated if the transaction amount exceeds the daily limit of the ATM and the payee wants to receive the entire transaction amount on the same day. The financial institution selected by the payee is then responsible for verifying the identity of the payee, preferably by means of the previously mentioned described identification verification device.

As indicated in block 4008, based on the FSTIN or TIN, the RPC system 450 attempts to match the identification information obtained from the payee's driver license 130 and/or other information entered by the payee with the payee identification information recorded by the payer 400 or otherwise available in the database of the RPC system 450.

If the identification information matches (YES branch 4009), and the specified amount has already been secured (FSTIN), the transaction is approved and the RPC system 450 will immediately transfer funds (block 4010) from the payer's RPC account in the RPC bank system 470 through an ATM network 475 or other similar secure real-time network to the payee 410, with the specified amount of cash being released to the payee 410 from the RPC terminal 555

Alternatively, if there is a match in the identification information but the specified amount has not already been secured (TIN), the RPC system 450 will now attempt to transfer the specified amount to the RPC system's bank account 470 from payer's account at the identified payer financial institution 460 through the real-time ATM (or other competing) network 465, whereupon the ATM terminal 555 can then issue cash payment (block 4010) to the payee 410 from the RPC bank account 470 via the ATM network 475. In either event, the specified amount of cash is released to the payee 410 only after the funds have been transferred from the payer's account 460 and the payment process is thus completed in a manner that either eliminates, or substantially reduces, any risk of fraud by payer, payee, or third parties.

On the other hand, if the information provided by the payee does not match (NO branch 4011), then the payment request is rejected (block 4012).

Those skilled in the art will realize that the secure networks 445, 465 and 475 can in practice be different secure paths over a common public network such as the Internet. Those skilled in the art will also realize it is possible to directly integrate RPC system 450 into existing ATM, credit card, or debit card networks. Moreover, due to the similarity between the RPC systems of the present invention and corresponding systems described in the referenced related applications, it is contemplated that they may be integrated into a single system that provides a universal anti-fraud payment system that can be used for all types of transactions.

In some embodiments of the present invention, the identification device at the payer terminal 405 or payee terminal 555 may be required to read a piece of biometric information such as a fingerprint, which will be verified with the information stored in the customer database of the RPC system or in the identification card. Note that the payer's biometric information is preferably available from the RPC database, while for a payee not already registered with the RPC system, the payee's biometric information may only be available from the payee's identification card. The login will not be approved for an account without a matching piece of biometric information of the account holder. If a business account is involved, the biometric information of the signer can be used. Driver's license numbers and social security numbers are standard information stored inside the customer database of financial institutions today, while biometric information is not stored yet. Due to privacy concerns and the high cost involved in the identification process, storing biometric information into the customer database of a financial institution may not be easily implemented. It may take some time to establish a biometric information database in the RPC system.

In another alternative embodiment of the present invention, the biometric information is stored inside the identification card 130. Once the account holder information obtained from the RPC system matches the information obtained from the identification card, the identification card is proven to be a valid one. Then, the biometric information stored inside the identification card can be used to authenticate the identity of the payer.

Several possible levels of security can be applied during authentication of an account holder during a login process by using different embodiments of the present invention. A mixed version of security levels is possible for practical business purposes. For example, different levels of security can be required based on the dollar amount involved in the transaction. Since the payee cannot initiate any transaction, all of the above embodiments and a mixed version of them can ensure that the payee cannot fabricate fake transactions based on the knowledge about the payer. Since third parties are excluded from the transactions, there is no chance for a third party to commit fraud. In practice, a trade-off among different security requirements may be chosen in order to provide the most cost-effective and user-friendly solution. Such a trade-off should not be construed as a deviation from the present invention.

Since payer's bank account numbers, credit card or debit card numbers are kept confidential by the RPC system, there is no room for fraud committed by the payee or any third party. Since payee has no way to initiate a transaction, the payee cannot commit fraud against payer. Especially if the transaction funds are immediately transferred out from the payer's account (when the FSTIN is used), the payer cannot commit fraud against payee.

In other embodiments of the present invention, an agent (not shown) can be jointly appointed by the payer and the payee to perform an equivalent escrow function based on the terms and conditions agreed upon between the payer and the payee. The procedure to issue payment and to receive payment is the same as the embodiments described in this document. However, the payment will not be released to the payee unless the appointed agent has authorized the action. Through this approach, both the payer's and the payee's interests are fully protected, and trading fraud is eliminated.

Workers skilled in the art and technology to which this invention pertains will appreciate that other alterations and changes in the described structure may also be practiced without meaningfully departing from the principal, spirit and scope of this invention.

1. A method for verification and processing of a remote transaction using cash as the payment instrument involving a payer's account at a financial institution, comprising:
opening a remote payment system account for the payer after verifying the payer's identity, payer's financial institution and the specific account at that institution;
authenticating the payer's identity when the payer logs into the remote payment system to conduct a remote transaction using cash as the payment instrument;
prompting the payer to enter the payee's name, identification information, and transaction amount into the database of the remote payment system;
assigning a transaction identification number which the payee will use to identify and request a cash payment;
prompting the payee to insert a machine-readable official identification card and enter the assigned transaction identification number into a remote payment system terminal;
verifying that embedded identification information read from the payee's identification card at the remote payment system terminal matches the payee information entered by the payer into the remote payment system database and that the specific amount of funds is available from the payer's account at the financial institution; and
if the verification of the payee's identity is successful and the specific amount of transaction funds are available, causing said remote payment terminal to issue a cash payment of that specific amount to the payee.

2. The method of claim 1 further comprising:
prompting the payer to submit a machine-readable official identification card prior to the opening of said remote payment system account, and
opening said the remote payment system account only if embedded identification information read from the payer's identification card matches the account holder information of the financial account identified by the payer.

3. The method of claim 2 further comprising:
prompting the payer to input an additional item of personal information not embedded in the identification card but stored in the remote database of the financial institution, and
verifying that the additional personal information input by the payer matches the personal information stored in the remote database.

4. The method of claim 3, wherein the personal information input by the payer includes at least part of a social security number.

5. The method of claim 3, wherein the personal information input by the payer includes at least biometric information.

6. The method of claim 5, wherein the biometric information input by the payer includes at least a fingerprint.

7. The method of claim 2 further comprising:
prompting the payer to input an additional item of personal information embedded in the identification card but not stored in the remote database of the financial institution, and
verifying that the additional personal information input by the payer matches the personal information embedded in the identification card.

8. The method of claim 7, wherein the additional personal information input by the payer includes at least a personal identification number.

9. The method of claim 7, wherein the additional personal information input by the payer includes at least biometric information.

10. The method of claim 9, wherein the biometric information input by the payer includes at least a fingerprint.

11. The method of claim 1 further comprising:
prompting the payer to log into the remote payment system with an official identification card, and
validating the login only if the embedded identification information read from the payer's identification card matches the account holder information in the remote payment system database.

12. The method of claim 11 further comprising:
prompting the payer to input an additional item of personal information not embedded in the identification card but stored in the database of the remote payment system, and
verifying that the additional personal information input by the payer matches the personal information stored in the remote payment system database.

13. The method of claim 12, wherein the personal information input by the payer includes at least part of a social security number.

14. The method of claim 12, wherein the personal information input by the payer includes at least biometric information.

15. The method of claim 14, wherein the biometric information input by the payer includes at least a fingerprint.

16. The method of claim 11 further comprising:
prompting the payer to input an additional item of personal information embedded in the identification card but not stored in the database of the remote payment system, and
verifying that the additional personal information input by the payer matches the personal information embedded in the identification card.

17. The method of claim 16, wherein the additional personal information input by the payer includes at least a personal identification number.

18. The method of claim 16, wherein the additional personal information input by the payer includes at least biometric information.

19. The method of claim 18 wherein the biometric information input by the payer includes at least a fingerprint.

20. The method of claim 1 further comprising:
prompting the payee to input an additional item of personal information not embedded in the identification card but stored in the database of the remote payment system, and
verifying that the additional personal information input by the payee matches the personal information stored in the database.

21. The method of claim 20, wherein the personal information input by the payee includes at least a password.

22. The method of claim 1 further comprising:
prompting the payee to input an additional item of personal information embedded in the identification card but not stored in the database of the remote payment system, and
verifying that the additional personal information input by the payee matches the personal information embedded in the identification card.

23. The method of claim 22, wherein the additional personal information input by the payee includes at least a personal identification number.

24. The method of claim 22, wherein the additional personal information input by the payee includes at least biometric information.

25. The method of claim 24, wherein the biometric information input by the payee includes at least a fingerprint.

26. The method of claim 1 further comprising:
including an escrow agent into the transaction based on the agreement between payer and payee, and the payee cannot receive payment unless the escrow agent has approved the payment first.

27. The method of claim 1, wherein the payer's financial account includes at least a bank account such as checking or savings account.

28. The method of claim 1, wherein the payer's financial account includes at least a credit card account.

29. The method of claim 1, wherein the payer's financial account includes at least a debit card account.

30. The method of claim 1, wherein the remote payment system terminal is incorporated into a self-service machine.

31. The method of claim 30, wherein the self-service machine includes at least an ATM terminal.

32. The method of claim 30, wherein the self-service machine includes at least a check-cashing terminal.

33. The method of claim 30, wherein the self-service machine includes at least a standalone kiosk where cash is available for withdrawal.

34. The method of claim 1, wherein the remote payment terminal is installed in a location under the supervision and control of the remote payment system.

35. The method of claim 1, wherein the remote payment system secures the payment funds from the specified payer account against the possible payer's fraud before issuing the transaction identification number.

36. The method of claim 1 further comprising:
permitting the payer's financial institution to open an account in the remote payment system on behalf of the payer.

37. The method of claim 36, wherein the payer's account in the remote payment system is linked to a specific payer's account of the financial institution opening said remote payment system account.

38. The method of claim 1, wherein:
the remote payment system is established exclusively for one financial institution to provide services to the customers of the financial institution.

39. The method of claim 1, wherein:
a wireless data transmission device is incorporated into the identification card; and
a wireless data receiver reads the machine-readable identification information of the identification card.

40. The method of claim 2, wherein:
a wireless data transmission device is incorporated into the identification card; and
a wireless data receiver reads the machine-readable identification information of the identification card.

41. The method of claim 11, wherein:
a wireless data transmission device is incorporated into the identification card; and
a wireless data receiver reads the machine-readable identification information of the identification card.
